(19) United States
(12) Patent Application Publication
(10) Pub. No.: US 2008/0233895 A1
(43) Pub. Date: Sep. 25, 2008

(54) Digital CB system

(76) Inventor: Christian D. Bizer, Piscataway, NJ (US)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 11/725,383

(22) Filed: Mar. 19, 2007

(51) Int. Cl. H04B 1/38

(52) U.S. Cl. 455/90.2

(57) ABSTRACT

A digital citizen band system includes several powered tower units dispersed along a plurality of drive routes. A single tower unit receives digital voice data in one of the channels from a single registered vehicle digital citizen band box in the vicinity of the tower and broadcasts digital voice data to all other registered digital citizen band boxes in the vicinity of the tower using two frequencies specific to the channel in the 824 to 894 megahertz range. The two fixed frequencies specific to each channel are fixed system-wide, enabling the vehicle to travel along the drive route seamlessly switching communication from one tower unit to the next. The tower unit has a shortwave antenna and receiver to receive office emergency information that is broadcast in a special communication, and as a multiplexed overlay to communication in all channels. The user may initiate an emergency alert for broadcast using the special communication channel.

### BACKGROUND OF THE INVENTION

1. Field of the Invention

The present invention relates to CB communication; and, more particularly, to a static free digital CB device adapted for communication between mobile registered users of a system that provides warning and other traffic sensitive local information in a timely manner.

2. Description of the Prior Art

Many patents address issues related to communication systems designed for communication between mobile users. These devices include analog CB systems, cell phones and the like. The devices communicate over a large distance which, in the case of cell phones, can span the country or world; and they are suited for obtaining local timely information. Analog communication devices are typically prone to static and signal domination by the nearby broadcasters. This is particularly the case for analog CB transmission and receiving devices.

U.S. Pat. No. 6,009,330 to Kennedy, III et al. discloses a method and apparatus for call delivery to a mobile unit. The call delivery system for delivering a call to a mobile unit on a vehicle includes both a data communications network and a mobile voice communications network. The mobile unit generates call delivery information and communicates this information to a platform using the data communications network. The mobile unit communicates how to contact it using a data link network to a platform, which is a satellite-based communication. Once the platform knows how to communicate with the mobile unit, the platform can use a cell phone network to communicate with the mobile unit. It is not clear why the satellite communication is needed to first locate the mobile unit, since eventually the cell phone is used for voice communication with the mobile unit. The '330 patent does not disclose a CB communication system. Rather, the system disclosed therein resembles a cell phone system having different cell phone addressing methodology, which does not rely upon use of assigned cell phone numbers. Local specific information is not provided by the '330 patent system in a timely manner.

U.S. Pat. No. 6,021,317 to discloses a dual antenna radiotelephone system, including an antenna-management matrix switch, and associated methods of operation. The dual antenna radiotelephones include antenna-management switching means that allow the radiotelephones to assume a plurality of different static and dynamic configurations, either adaptively or in response to user commands. These switching means also provide means for connecting the radiotelephone to one or more external antennas, and means for use of diverse reception and or transmission techniques. Two separate antennas are employed by the system. These antennas which are oriented or polarized differently, and connected to two separate receivers. The antenna switching system looks for the signal noise characteristics to determine the best choice of antenna-receiver combination to optimize communication. No disclosure is contained within the '317 patent concerning a CB system. Moreover, the disclosure of the '317 patent presumes that loss of signal is due to orientation or polarization of the antenna.

U.S. Pat. No. 6,252,884 to Hunter discloses a dynamic configuration of wireless networks. The system automatically and dynamically configures a wireless computer network. Each computer that is to participate in the dynamic network continuously broadcasts its address to any other computer within range of the wireless network hardware. When a computer receives a broadcast message from a machine it is not currently connected to, it can then use any standard communications protocol (i.e., TCP/IP) to establish a connection to the broadcasting machine. Once the connection is established, a message is sent to the broadcasting machine notifying it of the new connection. This allows for either client/server, peer-to-peer, or other communications strategies to be implemented, depending on the application. Upon establishing a new connection between a pair of computers, a data synchronization protocol is employed to exchange data, applications, or configure services. To avoid the occurrence of many disconnects, reconnects, and data synchronizations, a connection degradation strategy is employed. The '884 patent disclosure involves a wireless communication network between two computers. No disclosure is contained therein concerning a CB communication system. Only packets of data are transmitted between computers, not voice messages.

U.S. Pat. No. 6,373,430 to Beason et al. discloses a combined global positioning system receiver and radio. A portable GPS/radio unit communicates over a wireless radio network with at least one other unit, which is transmitting radio signals over the network indicative of that unit's location. The GPS/radio unit comprises a GPS receiver for receiving satellite signals from a plurality of satellites, a radio receiver for receiving the radio signals transmitted by the other unit, a processor for calculating the unit's location as a function of the received satellite signals and for identifying the location of the other unit based on the received radio signals, and a display for indicating the location of the other unit. A GPS device is combined with a radio transmitting and receiving device. Pressing control buttons allows the unit to broadcast GPS location information and receive GPS location information. The GBS location and voice communication are transmitted by radio transmission. The '430 patent does not operate in the manner of a CB system; but, instead, transmits GPS location data or voice messages over radio network. The hand held unit is unlikely to transmit information over a substantial distance, and is subject to radio interference problems.

U.S. Pat. No. 6,647,270 to Himmelstein discloses a vehicletalk system. The system provides a communication link among a plurality of mobile units. Each mobile unit comprises a broadband RF transceiver with an antenna, a GPS receiver, an audio-visual interface, an electro-mechanical interface and a microprocessor with associated memory. The system transmits voice or data communications comprising a plurality of data packets such as GPS position data between a plurality of remote units. Each remote unit has a unique identifier. The communication system is designed for transmitting information between a mobile unit within a vehicle traveling on a road and a fixed communication network installed on a roadside. The fixed communication network includes a base station having a transceiver for communicating with the vehicle by transmitting and receiving a plurality of communication packets. This communication can include payment instructions, security instructions and/or access codes, which can be transmitted with or without intervention by the vehicle operator. The mobile units communicate with each other or with a base station, providing data and voice communication. The data communicated may include GPS position, vehicle velocity, and vehicle acceleration information. The system may be ordered by police or authorities to control all functions of the vehicle. This data and voice communications system does not communicate voice digitally through a tower based powered unit. Instead it communicates to every other unit and a base station. The system disclosed by the '270 patent is not a digital CB system. Rather, the system disclosed by the '270 patent is primarily a data communication system.

U.S. Pat. No. 6,748,226 to Wortham discloses a system and method for locating a mobile unit within the service area of a mobile communications network. A differential positioning system includes components of a satellite-based or land-based positioning system and components of a mobile communications network. It uses a mobile unit such as a vehicle communicating with a plurality of satellites using pulses and establishing time of arrival of signals to calculate the location of the mobile unit. Further, the results are corrected by comparing the vehicle's position with that of a reference object whose position is precisely known and its time of arrival data is available. This scheme enables the precise determination of the position of the mobile vehicle. This is not a Digital CB System. There is no provision for voice communication with other vehicles.

U.S. Pat. No. 6,792,351 to Lutter discloses a method and apparatus for multi-vehicle communication. A vehicle receiving a message compares the identifier to see if the message is for the driver of the vehicle. If it is intended for the driver, the message is communicated to the driver. If the identifier does not match, the vehicle broadcasts the message to adjacent vehicles and the process continues. In this manner, each and every vehicle need not be in the communication range of a portal or a satellite station. The message delivered is not a voice communication. Each vehicle does not communicate voice communication with other vehicles, but merely repeats the digital message data together with identification data.

U.S. Pat. No. 6,828,924 to Gustavsson et al. discloses an integrated vehicle communications display. The communications system is adapted for use in a truck. The communications system includes a memory, a GPS based motion and/or location sensor, a display unit, a selector, and a transmitter. The communications system is used to safely send and receive messages in a heavy-duty truck or a highway tractor. This is a satellite based communication system where in the fleet office can directly send a message to the truck using a truck satellite antenna. Depending on the priority of the message, the truck driver can respond YES/OK or NO when the truck is moving. The truck driver can type in a detailed message, which is sent only when the truck is not in motion, as determined by a GPS or other truck sensor. This system only communicates data in the form of a text. There is no voice message delivered. The truck only communicates with the fleet office using a satellite communication and does not communicate with multiple truck drivers or other moving vehicles. In fact, large-scale data communication is prevented when the truck is moving.

U.S. Pat. No. 6,871,144 to Lee discloses a combined global positioning system receiver and radio with enhanced tracking features. A portable GPS unit communicates over a wireless radio network with one other such unit. The unit transmits radio signals over the network indicative of the unit's location and receives similar radio signals from the other units. The unit calculates and displays a route that may be followed to go to a moving waypoint such as one of the other units. The GPS receiver receives satellite signals from a plurality of satellites determining the location of a moving waypoint and allows a user to follow or go to a moving waypoint such as another GPS unit positioned in a car or other vehicle or carried by a hiker, biker, runner, or other person. This is a portable hand-held unit, which has a GPS senor and broadcasts its location to other hand held units while it receives GPS data from other hand held units. The position of another hand held unit is displayed in a window, which may also indicate a local area map. The system disclosed by the '144 patent is not a Digital CB System. There is no voice communication between the users. Only location information is graphically displayed. GPS satellites are used to determine the location of other hand held units.

US Patent Publication No. 2003/0040322 to Lection et al. discloses a global positioning family radio service and apparatus. A personal radio service (PRS) device is configured to engage in private, short-range two-way voice communications with another PRS device in range of the PRS device. The PRS units can have two-way private voice communication between parties having the hand-held device. The device also has GPS capability and transmits GPS data along with voice communication to the other hand held unit, which extracts encoded GPS information from an RF wireless transmission and displays the GPS data in a screen display. This is not a Digital CB System since it involves a private communication between two parties. It requires at least four satellites to be available for GPS information. The communication comprises both voice and data.

US Patent Publication No. 2003/0083024 to Richenstein et al. discloses a multiple channel wireless communication system. The wireless headphone receives signals from a transmitter, which combines several audio streams with control code. The control code is used by the wireless headphone to extract a specific audio stream from the combined transmitted signal. This is not a Digital CB system because no voice message is transmitted. It is only received by the wireless headphone. Infrared communication requires a direct line of visibility—a feature that is not required by a Digital CB system.

US Patent Publication No. 2003/0087608 to Gustavsson et al. discloses a multiple purpose antenna system. The system utilizes existing antennae for satellite communications purposes. This multiple purpose antenna system is adapted for installation on a highway truck to receive and transmit signals. It uses a standard antenna for transmitting and receiving signals from a satellite. The received satellite or other signal is separated in frequency by a multiplexer and a filter to send to a signal to separate receivers. The system disclosed by the '608 patent publication is not a Digital CB System. The CB communication is a standard analog communication, which is a portion of the signals handled by the antenna multiplexer.

US Patent Publication No. 2003/0087636 to Mazzara et al. discloses a method for providing multi-path communication for a mobile vehicle. This system is for providing multi-path communication for a mobile vehicle including at least a primary communication device. The availability of the primary communication device and a secondary communication device is determined in response to a service request. A capability of the primary communication device and the secondary communication device is first determined. A service request from one of the primary communication devices and secondary communication devices is based on the capability determination. A service request is then initiated from one of the primary communication devices and secondary communication devices. The method provides multi-path wide area network access for a mobile vehicle. This system links the vehicle to a WAN network to access multiple service providers including voice and digital data. The '636 patent publication does not operate in the manner of a Digital CB System. It simply accesses several providers for voice and digital data.

US Patent Publication No. 2003/0158614 to Friel et al. discloses an audio system for a vehicle with battery-backed storage. An audio system is mounted in a vehicle and provides playback of digital audio content stored in a semiconductor's dynamic random access memory (DRAM). Power from the vehicle's battery is constantly applied to the DRAM to retain information even when the vehicle is not operating. The audio content may be acquired by the recording of broadcast radio programs, by streaming content from a wireless Internet connection, from a CD, and/or from a wireless link to a computer. An updated play list may be provided to the DRAM on a periodic basis or manually under user control. A continuously powered DRAM stores digital music received from several sources and plays back the digital music in the car radio of a mobile vehicle. The '614 patent publication does not disclose a Digital CB system, since no voice message is transferred between mobile drivers.

US Patent Publication No. 2004/0198281 and Foreign Patent Publication No. WO 2004/038968 A1 to Lane disclose a transit vehicle wireless transmission broadcast system. The transit vehicle wireless transmission broadcast system wirelessly transmits multimedia content from one transit vehicle to another transit vehicle for passengers traveling in the transit vehicles. Each transit vehicle includes a receiver for receiving the multimedia content or storage device for retrieving the multimedia content and a transmitter for wirelessly transmitting the multimedia content to a receiver located on another transit vehicle. Each of the transit vehicles includes a broadcast device for broadcasting the multimedia content to the passengers. This is wireless multimedia transmission from one railroad car to another railroad car for the enjoyment of passengers. The disclosure of the '281 patent publication has nothing to do with a Digital CB System.

US Patent Publication No. 2004/0203568 to Kirtland discloses a computerized warning system interface and method. The computerized warning system interface is a computer programmed to link between existing systems, such as between a dam monitoring system and a communication network meant to alert individuals in the event of an emergency and/or disaster. The computer interface is programmed to receive signals generated from an existing emergency and/or disaster sensing and/or warning system(s), interpret the type of emergency and/or disaster, based on the signal(s), and activate a communications network to send the appropriate warning message(s) to individuals located in the region affected by the emergency and/or disaster. Warning messages are sent via wireless or wired telephones, pagers, CB radios, internet connections, etc., and/or other communication service providers providing service to land, water, air and space as well as being linked to public warning systems, etc. This is a centralized computerized warning device which receives data from number of sensors and other warning devices, interprets received data and delivers warnings to appropriate personnel using CB radio, a wired telephone, an internet connection over the internet communication line(s), and other personal communication means. The disclosure of the '568 patent publication does not suggest a Digital CB System. No voice communication is exchanged by mobile drivers. Rather, a computer interconnection gathers sensors and other warning systems to interpret danger potential.

Foreign Patent Publication No. WO 026/883 A3 to Diaz et al. discloses a land vehicle communication system and process for providing information and coordinating vehicle activities. A communication system coordinates various activities of a land vehicle including providing information about maintenance providers, optimal route for load pick up and delivery and the like. The communication provided by the system is computer-generated data, not voice communication. Therefore, this system does not disclose a Digital CB system.

Foreign Patent Publication No. WO 02005/053323A to Speasl et al. discloses groupware systems and methods. This is a memory stick device which is compatible with a number of computer based systems such as a cellular phone, personal digital assist, digital appliance, compatible printers, digital cameras, compliant stereo system or other computer device, via a compatible memory interface and carries specialized user specific software. This system does not disclose a Digital CB system.

Internet Publication “XM Satellite CB Radio”, source(s) at http://www.sagermotorsports.com/122104/truckpics-Pages/Image8.html (hereinafter, “the 'CB Radio Internet publication”) discloses a combination of XM satellite radio with a CB unit, as shown in the FIGURE below. The XM satellite radio and the CB unit are separate units and do not operate in the manner of a Digital CB System which provides communication between mobile drivers that provides static or noise free, fade resistant, reliable voice message transmission over long distances.

There remains a need in the art for a digital CB system that communicates to nearby trucks and cars without static or high volume playback due to signal distortion produced by other CB radio operators in the immediate vicinity. There is also a need for a digital system that receives alert notifications operative to effect the immediate location of a vehicle in a timely manner, wherein the alert is generated by the users of the system and broadcast by a computer based artificially intelligent system administrator when deemed appropriate.

### SUMMARY OF THE INVENTION

The Digital CB (citizens band) System is a small box powered by battery or vehicle power and is a free standing device capable of communicating to and receiving communication from other trucks or automobiles fitted with a similar digital CB box through a stationary broadcasting tower unit. The Digital CB system allows static-free communication by registered users and prevents interference from other signals in close proximity to the caller. Users of the Digital CB system must obtain a special box and register under an account number, and each of the users is held individually accountable for his activity.

The Digital CB system comprises a battery powered or vehicle alternator powered Digital CB box located inside a moving vehicle such as a truck or an automobile. The Digital CB box communicates digitally with a powered receiving and message broadcasting unit, which is present in a tower having a construction similar to a cell telephone tower, herein after designated as “tower unit”.

The tower unit uses a digital system identification code, SID, to determine whether a Digital CB box is a registered unit serviced by the Digital CB system. Upon being located, the Digital CB box is immediately authenticated and listed in a database maintained within the tower unit. In this manner, the tower unit recognizes all the Digital CB boxes present within its tower communication range, and is capable or receiving voice messages from and broadcasting voice messages to these Digital CB boxes. The Digital CD box has a plurality of channels available for selection by the user. Each individual channel is assigned with two fixed frequencies, one for receiving and one for broadcasting voice messages and all the tower units dispersed along the drive route use the same two fixed specific frequencies for that particular channel, providing continuity of communication as the vehicles travel along the drive route. The digital CB system uses digital communication frequencies in the FCC permitted 824 to 894 megahertz band range. Since this frequency range is large and digital communication required for digital communication is small, a number of channels, each with two defined sending and receiving frequencies may be packed efficiently within the stated frequency range of 824 to 894 megahertz range. This mode of communication is effective primarily because an individual tower communicates with vehicles in its immediate neighborhood. Communications are therefore restricted to vehicles in the local neighborhood. Consequently, as vehicle drivers pass through from one tower control to the adjacent second tower control region, the second tower recognizes the presence of the vehicles by the SID code and the tower to tower communication protocols passes the communication seamlessly allowing communication to proceed.

When a user speaks using a digital CB box, the enabled communication between the tower unit and the digital CB box allows the tower unit to receive the voice communication at the first frequency. At this time, the use of first frequency by the user is immediately recognized by all the Digital CB boxes in the neighborhood of the tower unit to be a ‘busy’ frequency and all other users are prevented from communicating with the tower unit. The tower unit broadcasts the first user's voice message using a second frequency so that all the Digital CB boxes in the region communicating to the tower unit receive the voice message and play the message using speakers provided within the Digital CB box. The speaker of the Digital CB box in the moving vehicle of the user communicating with the tower unit is muted to prevent sound feedback. When the first user completes the voice message, the first frequency is indicated to be ‘free’ and another user can now communicate with the tower unit, which communication typically comprises a reply to the first user's message. The voice messages from the Digital CB box and tower unit are communicated digitally, and standard message compression algorithms can be employed to use a narrow frequency bandwidth for noise free communication. The Digital CB box has several ‘channels’ through which a user can communicate with the tower unit and receive a broadcast back from the tower. If there is too much conversation in channel 12, for example, the user may ask interested users to switch to channel 14 to continue discussions.

In addition to the ‘talk’ channels, a special channel may be available for communicating to all the users of official information such as ‘delay near exit 22 of a major highway’ or ‘sleet conditions at a given ramp’. For this purpose, the tower unit is attached to a short wave antenna and receiver, which receives voice messages broadcast by authorities. This voice message is broadcast by the tower unit in a specific designated channel in the Digital CB box as well as a multiplexed broadcast over the existing communication in all channels. The user may tune to the special channel, where the alert information is periodically repeated. This special channel broadcasts highway problems or other safety issues to all users of the Digital CB system.

The user may use the alert channel to broadcast to the tower an alert or current highway condition. The administrator software resident in the shortwave receiver box analyzes this information and may broadcast this to other appropriate tower units. These tower units broadcast the alert information to all registered users in the vicinity of the tower. The alert information may be an official broadcast issued by the authorities or that generated by analyzing user reports.

All tower units use the same two frequency pairs for a specific channel to receive and broadcast voice messages. Accordingly, the Digital CB System is transparent to the user as a truck or vehicle moves from the communication zone of one tower unit to the next. The conversations can be continued across the boundaries between areas serviced by two adjacent tower units. The tower units may use the short wave antenna to communicate with an adjacent tower unit during this call transfer. If someone else is broadcasting in the adjacent tower unit communication zone, the original user who is communicating with the original tower unit receives an indication that the communication channel is ‘busy’. Upon receiving this signal, the user must wait until the communication channel is ‘free’ to pick up the conversation. Therefore the system operates seamlessly as the mobile user moves from one tower unit controlled region to the next.

This system, as detailed below, is far easier to manage than a cell phone system. The latter assigns dynamically two frequencies to each cell phone which is required to switch frequencies around as the user moves from one tower to the next. The cell phone user is provided with only one channel for communication. By way of contrast, the Digital CB system uses a pre-programmed frequency pair for communication in each channel. The user can accordingly change channels to have a less crowded communication channel for communication with interested users. The system also provides a special official information channel, which is available to everyone.

When using the Digital CB System, people needing to correspond are not eclipsed by stronger signals in close proximity to the caller. Users of the Digital CB System must register under an account number, and each of the users is held individually accountable for his activity. Preferably, the Digital CB System comprises different channels available for selective communication to interested users. Optionally, the Digital CB System further comprises different, designated channels for specific purposes. For example, various channels can correspond to various languages, a channel can be specifically designated for “help”, a channel can be specifically designated for “directions”, and so forth. In an alternative embodiment, the Digital CB box is associated with a satellite radio receiver (e.g. Sirius® or XM® satellite radio service), an AM/FM radio or CD player. In this embodiment, the System can be switched between Digital CB service, satellite radio service, AM/FM radio or CD player.

### BRIEF DESCRIPTION OF DRAWINGS

The invention will be more fully understood and further advantages will become apparent when reference is had to the following detailed description and the accompanying drawings, in which:

FIG. 1 is a schematic diagram illustrating the Digital CB System.

### DESCRIPTION OF THE PREFERRED EMBODIMENTS

Conventional CB radios typically utilize extant airwaves to convey messages, such as emergency announcements, directions, and other assistance of a general nature. These messages are often conveyed between truck drivers on the open roads. Currently, terrestrial CB radio communication allows virtually anyone with a CB radio to interfere with the communications of other users. This communication is generally between two vehicles within communication range. The intensity of signal reception decreases rapidly as a function of distance, and conversations are overpowered by vehicles that are close by, resulting in “rambled” communications. Because of this interference, vital information is not delivered effectively and reliably.

Generally stated, the Digital CB System comprises several Digital CB (citizens band) boxes, each box provided with a speaker and a microphone for digital communication with a single stationary tower unit located close by. The Digital CB System is especially well suited for use by truck drivers associated with the professional trucking industry. The Digital CB System allows communication by registered users and prevents interference from other signals in close proximity to the caller.

The Digital CB System initiates communication when it enters the communication zone of the tower, providing a system identification code or SID, so that the tower unit verifies that the Digital CB box is serviced by the Digital CB System. Thus every Digital CB box within the communication zone of a tower unit is registered and the tower unit maintains a database of the whereabouts of Digital CB boxes for billing and other purposes. The Digital CB boxes communicate with the tower unit, using a preset frequency, and receive broadcasts from the tower in another preset frequency. The Digital CB box has a number of channels available for communication, and each channel has two present frequencies for sending and receiving voice messages. The tower unit accepts a voice message from one Digital CB box and broadcasts the received voice message to all Digital CB boxes using the second frequency allowing all users in the communication zone to receive the message. When the user is communicating with the tower unit, the first frequency channel is open, and any other user can communicate to the tower unit, establishing a conversation. The user may change channels to pick up some other communication or request a particular responder to move to a designated channel.

The Digital CB boxes also have provisions to receive special traffic or other alert information in a separate designated alert channel, where the information is periodically repeated, or as a multiplexed broadcast over the communication in all channels. Since this special channel has two frequencies, just like every other channel of the Digital CB System, a user may broadcast an observed alert or traffic situation to the local tower. The intelligent software present in the tower analyzes this information and broadcasts to other adjacent series of towers that transmits the alert information sequentially from tower to tower, based on the area of interest. For example, if a user observes lane closure in a tunnel, the local tower receives this alert from the user, analyzes the data, and broadcasts the data to the towers in the effected drive route. These towers broadcast the alert data in the specially designated channel and as a multiplexed overlay to the existing communication in all channels. The special channel also broadcasts official information, particularly traffic alert or safety information, that is broadcast from the tower unit. The official information from authorities is received by the tower as a radio broadcast through a tower mounted short wave antenna.

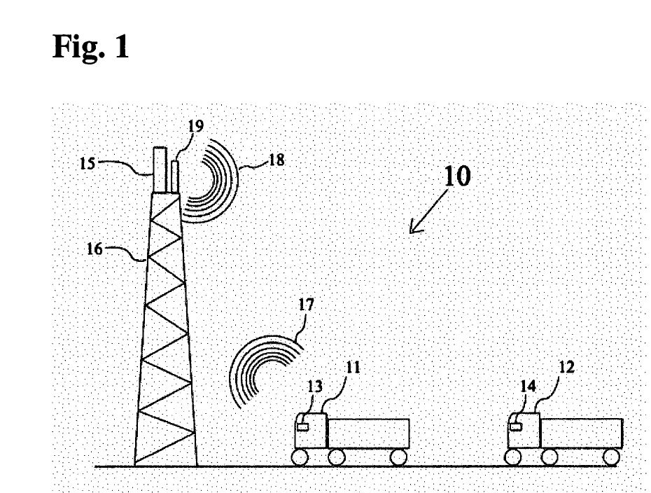

FIG. 1 illustrates a schematic diagram of the Digital CB System 10. The FIGURE shows two trucks 11 and 12 with Digital CB boxes 13 and 14 respectively. The Digital CB boxes are in communication with a tower unit 15 located nearby in a cell tower 16. The voice message from truck 11, Digital CB box 13 is digitally communicated to the tower unit 15 by waves 17. The tower broadcasts this received message on a different frequency as shown by waves 18. This broadcast is received by all Digital CB boxes in the communication zone of the tower unit, for example truck 12 with the Digital CB box 14. The tower has a short wave antenna for communicating with other tower units during transfer of a call or for receiving official information broadcast by the system administrator.

The Digital CB System comprises, in combination, the following salient features:
1. a tower unit digitally communicating with several Digital CB boxes located in trucks and mobile vehicles in a plurality of communication channels;
2. each Digital CB box in the communication zone of a tower unit registering with said tower unit by broadcasting first a system identification code so that the tower unit recognizes said Digital CB box as being serviced by said Digital CB System;
3. said tower unit logging all Digital CB boxes in the communication range in a database for billing and other monitoring functions;
4. said digital communication being centered within FCC permitted communication frequencies in the range of 824 to 894 megahertz;
5. said Digital CB box communication channels including a plurality of talk channels and a special channel providing official information;
6. optionally, talk channels including channels adopted for communication in various languages, a channel specifically designated for “help”, a channel specifically designated for “directions”, and so forth;
7. each digital communication talk channel of the Digital CB box having two fixed frequencies, a first fixed frequency for communicating with the tower unit and a second fixed frequency for receiving a voice message broadcast by said tower unit;
8. the frequencies used by each digital communication talk channel being set in the hardware of the Digital CB box and in the hardware of each tower unit;
9. said tower unit allowing only one user's Digital CB box to communicate therewith and presenting a ‘busy’ signal to all other Digital CB boxes in the tower unit's communication range;
10. said tower unit broadcasting to all Digital CB boxes instantly the voice message of the Digital CB box communicating with the tower unit, and changing its communication status from ‘busy’ to ‘free’ when a user's Digital CB box stops communication therewith;
11. said mobile Digital CB box seamlessly transferring from one tower unit to an adjacent tower unit due to each channel using the same two frequencies in all towers;
12. a user broadcasting an alert message to the local tower using the special communication channel, and the intelligent software resident in the tower analyzing the information and optionally broadcasting to all the registered users in the vicinity of the tower in a special communication channel and as a multiplexed overlay to the existing communication, as well as communicating alert information to appropriate adjacent towers in the drive route for relaying the alert information;
13. said official information being received by the tower unit from a radio antenna receiver and repeatedly broadcast by the tower unit in the special official communication channel that is multiplexed over the current talk channel to all Digital CB boxes within the communication zone of the tower unit.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. A citizen band communication system, comprising:
a. a plurality of tower units dispersed along a drive route;
b. a single local tower unit digitally sending and receiving voice data from a plurality of powered digital citizen band boxes within trucks or automobiles in the vicinity of said local tower;
c. said single tower unit communicating to official alert data transmission by short wave communication antenna and receiver;
d. each of said powered digital citizen band boxes registering with a local tower unit using a digital system identification code;
e. said digital citizen band box having a number of communication channels, each single channel using two system-wide fixed frequencies in the 824 to 894 megahertz range, one for sending digital voice data from a microphone to said tower unit and one for receiving voice data from said tower and playing in one or more speakers;
f. said single channel, upon receipt of voice data from a single digital citizen band box, marking the channel ‘busy’ for all other digital citizen boxes in the vicinity of said local tower and said local tower broadcasting said voice data to said all other digital citizen band boxes;
whereby non-garbled, clear voice communication is established between registered users of said digital citizens band system regardless of the distance between users.

2. A citizen band communication system as recited by claim 1, wherein said communicating channels include a special communication channel for receiving traffic alerts and emergency information broadcast by said single tower unit.

3. A citizen band communication system as recited by claim 2, wherein emergency information is broadcast as a multiplexed overlay over all existing channel communications.

4. A citizen band communication system as recited by claim 2, wherein said special communication channel is employed by a user to communicate to the tower an alert condition for analysis and broadcast to said all other digital citizen band boxes in the vicinity of said local tower and for sequential relay to other adjacent tower units.

5. A citizen band communication system as recited by claim 1, wherein said single channel communication between said registered users continues as said users travel along said drive route, the communicating towers switching from a single tower unit to an adjacent tower unit due to fixed two frequencies for each channel across the digital citizen band system.

6. A citizen band communication system as recited by claim 1, wherein said digital citizen bandboxes are powered by a truck/automobile battery.

7. A citizen band communication system as recited by claim 1, wherein said digital citizen bandboxes are powered by truck/automobile alternator generated power.

8. A citizen band communication system as recited by claim 1, wherein said tower units are powered by a land based power supply.

9. A citizen band communication system as recited by claim 1, wherein said tower units communicate with each other by short wave communication during relay of emergency information.

10. A citizen band communication system as recited by claim 1, wherein said tower units communicate with each other using system identification code communication during relay of emergency information.

11. A citizen band communication system as recited by claim 1, wherein said communicating channels include a ‘help’ channel’.

12. A citizen band communication system as recited by claim 1, wherein said communicating channels include a ‘direction’ channel’.

13. A citizen band communication system as recited by claim 1, wherein said digital citizen band includes one or more devices selected from AM/FM radio, CD player and satellite radio receiver.
